(19) United States
(12) Patent Application Publication
(10) Pub. No.: US 2015/0303638 A1
(43) Pub. Date: Oct. 22, 2015

(54) Pigtail Pliers

(71) Applicant: Steven Collie, Reno, NV (US)

(72) Inventor: Steven Collie, Reno, NV (US)

(21) Appl. No.: 14/254,533

(22) Filed: Apr. 16, 2014

(51) Int. Cl. H01R 43/22; B25B 7/02

(52) U.S. Cl. CPC H01R 43/22; B25B 7/02

(57) ABSTRACT

Disclosed is a pair of pliers adapted to remove and replace a pigtail comprising a handle; a neck connected to the handle, the neck including a fulcrum; a set of C-clamp jaws connected to the neck opposite of the handle; the neck is bent at a bend point, the bend point located between the fulcrum and the jaws, thereby offsetting the C-clamp jaws from the neck at an offset angle. There is a foot at the end of each C-clamp jaw adapted to grasp the pigtail. When the pliers are closed the feet come in contact with each other and a gap is formed between the rest of the jaws.

### CLAIM TO PRIORITY OF EARLIER FILED APPLICATION(S)

None.

### CROSS-REFERENCE TO EARLIER FILED APPLICATION(S)

None.

### FIELD OF THE INVENTION

The present invention relates to hand tools such as pliers. Specifically, the present invention provides a solution for removing and replacing pigtails.

### BACKGROUND OF THE INVENTION

In the electrical arts, a “pigtail” is defined as a short, flexible wire used in connecting a stationary terminal with a terminal having a limited range of motion. Pigtails are ubiquitous. Pigtails are common in automobile engines and dashes, airplane engines and dashes, helicopter engines and dashes, lawnmowers, appliances, boats, sound and video/entertainment systems, and other types of vehicles and machines. Pigtails generally are used where electrical wiring needs to be accomplished in a tight space such as inside of an engine or an appliance. Pigtails help organize and structure complex wiring done in a tight space.

As with everything, over time pigtails deteriorate and need to be removed and replaced. This is especially so for pigtails used outdoors such as those used in vehicles. In vehicles, the pigtails are exposed to extreme heat, cold, rain, snow, salt, oil, dirt, and other environmental challenges.

Because pigtails are positioned in tight areas such as the inside of an engine, it is often very difficult to remove and replace them. Conventional tools (usually pliers of some kind) usually cannot reach the pigtails location. With currently available pliers, the pigtail often must be pulled out by grasping the wiring connected to the pigtail because the pigtail itself is unreachable. This risks damage to the insulation of the wiring. Putting in the new pigtail is also difficult because conventional pliers often cannot reach the desired location.

### SUMMARY OF THE INVENTION

Quite simply, the present invention permits the user to efficiently remove and replace pigtails located in hard-to-reach places, by permitting the user to reach into these tight areas to grip the pigtail. Such hard-to-reach places include the area behind the dashboard of a vehicle and the area in the back of an engine where the transmission meets the engine block (this area is known as the “firewall”).

The present invention comprises a specialty set of pliers having jaws offset from the neck. This offset allows the user to reach into tight areas to grip the pigtail. Conventional straight pliers would not fit into such tight areas. The present invention may also include gapped C-clamp jaw adapted for gripping a pigtail. The feet may include crossing grooves to improve grip on the pigtail. A soft, grippable handle is also helpful.

### ADVANTAGES OF THE INVENTION

One of the advantages of this invention is that it provides a tool to efficiently remove and replace pigtails located in hard-to-reach places, such as the area behind the dashboard of a vehicle or the area in the back of an engine, by permitting the user to reach into these tight areas to grip the pigtail. Conventional tools usually cannot reach pigtails in these locations.

### BRIEF DESCRIPTION OF THE DRAWINGS

FIGS. 1 and 2 are substantially top perspectives of the preferred embodiment of the present invention, and

FIGS. 3 and 4 are substantially side perspectives of the preferred embodiment of the present invention.

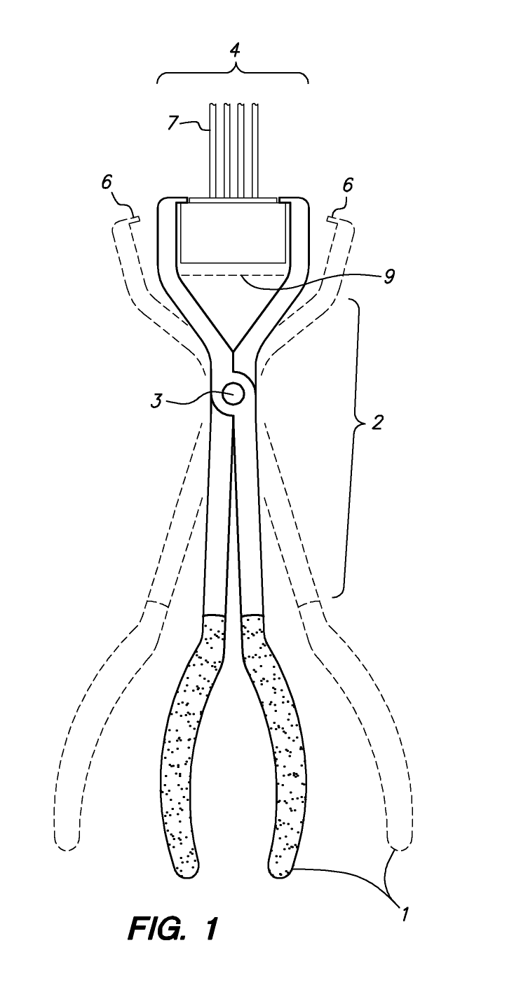

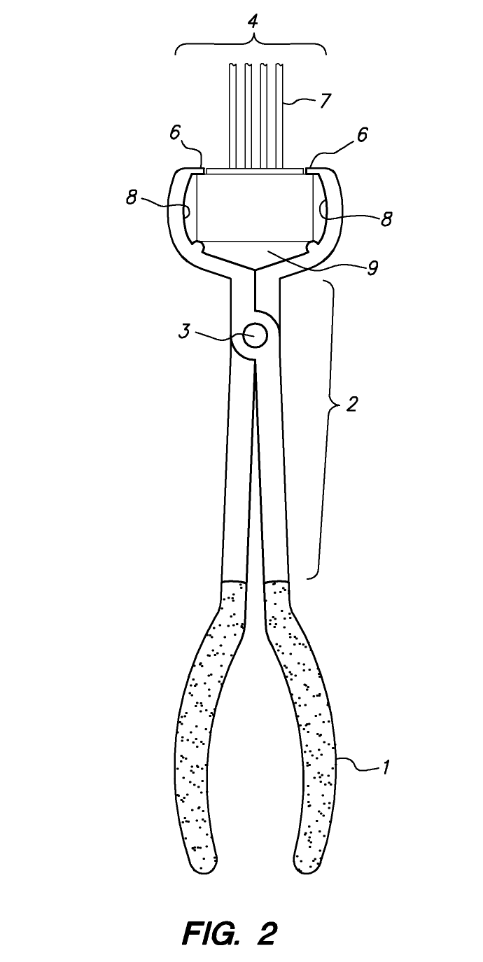

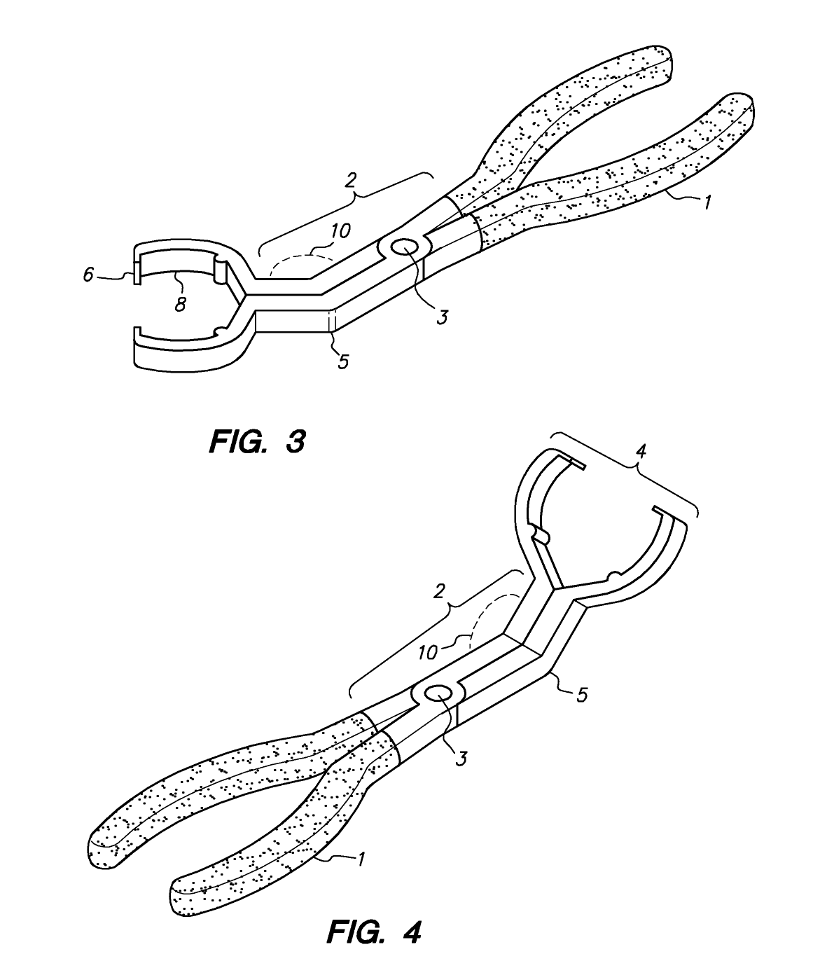

### DETAILED DESCRIPTION OF THE INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings and the element that each reference number corresponds to and a brief description:

1. Handles. The Handles 1 are connected to the Neck 2, and in the preferred embodiment, may be soft and grippable.

2. Neck. The Neck 2 is connected to the Handles 1 on one side and to the C-Clamp Jaws on the other side. The Neck 2 includes a Fulcrum 3 and a Bend Point 5.

3. Fulcrum. The Fulcrum 3 is included in the Neck 2 between the Handles 1 and the Bend Point 5.

4. C-Clamp Jaws. The C-Clamp Jaws 4 are connected to the Neck 2 opposite the Handles 1.

5. Bend Point. The Neck 2 is bent at the Bend Point 5, which is located between the Fulcrum 3 and the C-Clamp Jaws 4, thereby offsetting the C-Clamp Jaws 4 from the Neck 2 at an Offset Angle 10.

6. Feet. The Feet 6 are located at the end of each C-Clamp Jaw 4 and are adapted to grasp the Pigtail 7.

7. Pigtail. The Pigtail 7 is the item to be grasped by the C-Clamp Jaws 4 and by the Feet 6 and Crossing Grooves 8 of the C-Clamp Jaws 4.

8. Crossing Grooves. In the preferred embodiment, the Crossing Grooves 8 are located in the C-Clamp Jaws 4, and are used to improve gripping.

9. Gap. The Gap 9 is the space formed between the C-Clamp Jaws 4 when the Feet 6 and the C-Clamp Jaws 4 are grasping the Pigtail 7.

10. Offset Angle. The Offset Angle is the angle by which the C-Clamp Jaws 4 are offset from the Neck 2. In the preferred embodiment, the Offset Angle 10 may be either 30 degrees, 45 degrees, 60 degrees, or 90 degrees, and the Offset Angle 10 may be either vertical or horizontal.

### DISCLAIMER

Although the present invention has been explained in relation to its preferred embodiment, it is to be understood that many other possible modifications and variations can be made without departing from the spirit and scope of the present invention.

What is claimed is:

1. A pair of pliers adapted to remove and replace a pigtail comprising:
a. a handle;
b. a neck connected to the handle, the neck including a fulcrum;
c. a set of C-clamp jaws connected to the neck opposite of the handle;
d. wherein the neck is bent at a bend point, the bend point located between the fulcrum and the jaws, thereby offsetting the C-clamp jaws from the neck at an offset angle;
e. a foot at the end of each C-clamp jaw adapted to grasp the pigtail;
f. wherein when the pliers are closed:
i. the feet come in contact with each other; and
ii. a gap is formed between the rest of the jaws.

2. The pliers of claim 1, wherein the offset angle is 45 degrees.

3. The pliers of claim 1, wherein the offset angle is 90 degrees.

4. The pliers of claim 1, wherein the offset angle is 30 degrees.

5. The pliers of claim 1, wherein the offset angle is 60 degrees.

6. The pliers of claim 1, wherein the feet have crossing grooves to improve gripping.

7. The pliers of claim 1, wherein the handle is coated by a non-slip material.

8. The pliers of claim 1, wherein the jaws are needle nosed jaws.
